(19) United States
(12) Patent Application Publication
(10) Pub. No.: US 2019/0135159 A1
(43) Pub. Date: May 9, 2019

(54) COOLING APPARATUS AND A VEHICLE INCLUDING THE SAME

(71) Applicant: CHIN TE JAN CO., LTD., Kaohsiung City (TW)

(72) Inventor: CHIN-TE LEE, Kaohsiung City (TW)

(21) Appl. No.: 15/833,743

(22) Filed: Dec. 6, 2017

(30) Foreign Application Priority Data
Nov. 7, 2017 (TW) 106138481

(51) Int. Cl. B60P 3/20; F25B 19/00; F25D 11/00

(52) U.S. Cl. CPC B60P 3/20; F25B 19/005; F25B 2500/21; F25B 2500/05; F25D 11/003

(57) ABSTRACT

A freezing apparatus invention is configured to be used for a refrigerating space. The freezing apparatus includes a liquefied gas supply module having a liquefied gas tank. A control module includes an electromagnetic valve intercommunicating with the liquefied gas tank and a control unit electrically connected to the electromagnetic valve.

A cooling module is mounted in the refrigerating space and includes a vaporization chamber intercommunicating with the electromagnetic valve. An exhaust module includes an exhaust valve intercommunicating with the vaporization chamber. The exhaust valve is electrically connected to the control unit.

### CROSS REFERENCE TO RELATED APPLICATIONS

The application claims the benefit of Taiwan application serial No. 106138481, filed on Nov. 7, 2017, and the entire contents of which are incorporated herein by reference.

### BACKGROUND OF THE INVENTION

### 1. Field of the Invention

The present invention relates to a freezing apparatus and a vehicle including the freezing apparatus and, more particularly, to a freezing apparatus for controlling a phase change of a high-pressure liquefied gas to absorb heat energy and to thereby generate a temperature reducing effect as well as a vehicle including the freezing apparatus.

### 2. Description of the Related Art

Goods and materials, such as fresh food, frozen goods, biological samples, and industrial materials, that must be preserved at a low temperature, can be placed in a thermally insulated space, and a freezing apparatus can be used to remove heat from the thermally insulated space. The thermally insulated space can isolate entrance of external heat energy to maintain the low temperature environment for preserving the goods and substances. The thermally insulated space can be disposed in a factory or a vehicle.

A type of conventional freezing apparatus requires a compressor to repeatedly compress a coolant in a cycling tube. The coolant undergoes procedures including pressure reduction, transformation from a liquid state into a gaseous state, and gas expansion, thereby absorbing heat. Thus, the temperature of a pressure reduction section of the cycling tube can be rapidly reduced to thereby reduce the ambient temperature. Another type of conventional freezing apparatus uses a steel tank receiving a high-pressure liquefied gas that is gradually released into a refrigerating space. The liquefied gas rapidly vaporizes at normal temperature and normal pressure and absorbs a significant amount of heat energy to thereby provide a rapid refrigerating effect.

Use of a compressor in the above conventional freezing apparatuses occupies a considerable space and increases the overall weight, which causes limitation to the storage space and which is detrimental to transportation. Furthermore, the compressor has to be driven by a power source or the engine of the vehicle, which generates waste gas and noise while consuming extra energy. Furthermore, the low temperature environment cannot be maintained when power failure occurs or the engine cannot be started, leading to the risk of losing the refrigerating effect.

A further type of freezing apparatus uses a gas that is liquefied by pressure in advance, such that no extra power source is required during the cooling procedure. However, it is difficult to control the temperature reducing speed and the target temperature. Furthermore, the liquefied gas is an inert, pure substance, such as nitrogen or carbon dioxide. During use of the liquefied gas in a sealed space, when the component pressure of oxygen decreases as the amount of the liquefied gas increases gradually, workers could suffocate due to hypoxia.

In view of this, improvement to the conventional freezing apparatuses and vehicles including the conventional freezing apparatuses is necessary.

### SUMMARY OF THE INVENTION

To fix the above problem, the present invention provides a freezing apparatus that does not have to be driven by an additional power source that is easy to operate, and that can be moved easily.

Another objective of the present invention is to provide a freezing apparatus using a gas that vaporizes after absorbing heat will not enter the storage space, avoiding sudden temperature drop and suffocation of workers.

The present invention further provides a vehicle including the freezing apparatus that can maintain goods at a low temperature during transportation, reducing costs and consuming less energy.

A freezing apparatus according to the present invention is configured to be used for a refrigerating space. The freezing apparatus includes a liquefied gas supply module having a liquefied gas tank. A control module includes an electromagnetic valve intercommunicating with the liquefied gas tank and a control unit electrically connected to the electromagnetic valve. A cooling module is mounted in the refrigerating space and includes a vaporization chamber intercommunicating with the electromagnetic valve. An exhaust module includes an exhaust valve intercommunicating with the vaporization chamber. The exhaust valve is electrically connected to the control unit.

The freezing apparatus according to the present invention uses a liquefied gas that transforms from a liquid state into a gaseous state in the vaporization chamber while absorbing a large quantity of heat energy to supply the heat of vaporization. The sudden temperature drop of the vaporization chamber can be used to refrigerate the refrigerating space. Thus, the freezing apparatus according to the present invention does not need any compressors and, thus, saves energy and is not limited by the power source. Furthermore, waste gas and noise are not generated. Furthermore, in the freezing apparatus according to the present invention, the vaporization undergoes in the vaporization chamber, but the liquefied gas does not enter the refrigerating space during the vaporization procedure, providing a uniform temperature reducing effect while preventing a worker in the refrigerating space from inhaling a large amount of liquefied gas and from subsequent hypoxia and suffocation.

In an example, the liquefied gas tank stores a liquefied gas, and the liquefied gas is liquefied nitrogen or liquefied carbon dioxide. Thus, the liquefied gas can absorb a large quantity of heat energy during vaporization without chemical reaction with the frozen articles, providing refrigerating and preserving effects for the articles.

In an example, a pressure reducing valve and a pressure gauge are mounted to an outlet of the liquefied gas tank. Thus, the pressure and flow of the outputted liquefied gas can be controlled to know the residual amount of the liquefied gas, providing an assistance in replacement of the liquefied gas tank.

In an example, a needle valve is mounted between the electromagnetic valve and the liquefied gas tank. Thus, the output of the liquefied gas can be cut off, providing an assistance in adjusting or protecting the electromagnetic valve.

In an example, the vaporization chamber is coil-shaped. Thus, the volume and the area of an outer surface to be heated during vaporous expansion, increasing the heat absorbing efficiency.

In an example, a plurality of blades is mounted to an outer surface of the vaporization chamber to increase the area to be heated, increasing the heat absorbing efficiency and accelerating the temperature reducing effect.

In an example, a fan is mounted to an outer side of an end of the vaporization chamber and is electrically connected to the control unit. Thus, the fan can be activated to draw air to flow through the outer surface of the vaporization chamber. The cool air losing the heat energy is inputted into the refrigerating space, increasing the heat absorbing efficiency and the cycling effect of the cool air.

In an example, a pressure detection unit is electrically connected to the control unit and intercommunicates with the vaporization chamber. The pressure detection unit can be a pressure transducer. Thus, the pressure in the vaporization chamber can be detected and controlled, maintaining vaporization and avoiding damage to the pipes by high pressure.

In an example, a temperature detecting unit is electrically controlled to the control unit and is mounted in the refrigerating space. The temperature detecting unit can be a thermometer. Thus, the freezing temperature can be known in real time, and a target temperature can be set, thereby controlling the temperature reducing speed.

A vehicle according to the present invention includes the above-mentioned freezing apparatus and can be used to transport articles preserved at a low temperature without the need of compressors, saving the space and reducing the load.

The present invention will become clearer in light of the following detailed description of illustrative embodiments of this invention described in connection with the drawings.

### BRIEF DESCRIPTION OF THE DRAWINGS

FIG. 1 is a diagrammatic view of a freezing apparatus of a first embodiment according to the present invention.

FIG. 2 is a diagrammatic view of a freezing apparatus of a second embodiment according to the present invention.

### DETAILED DESCRIPTION OF THE INVENTION

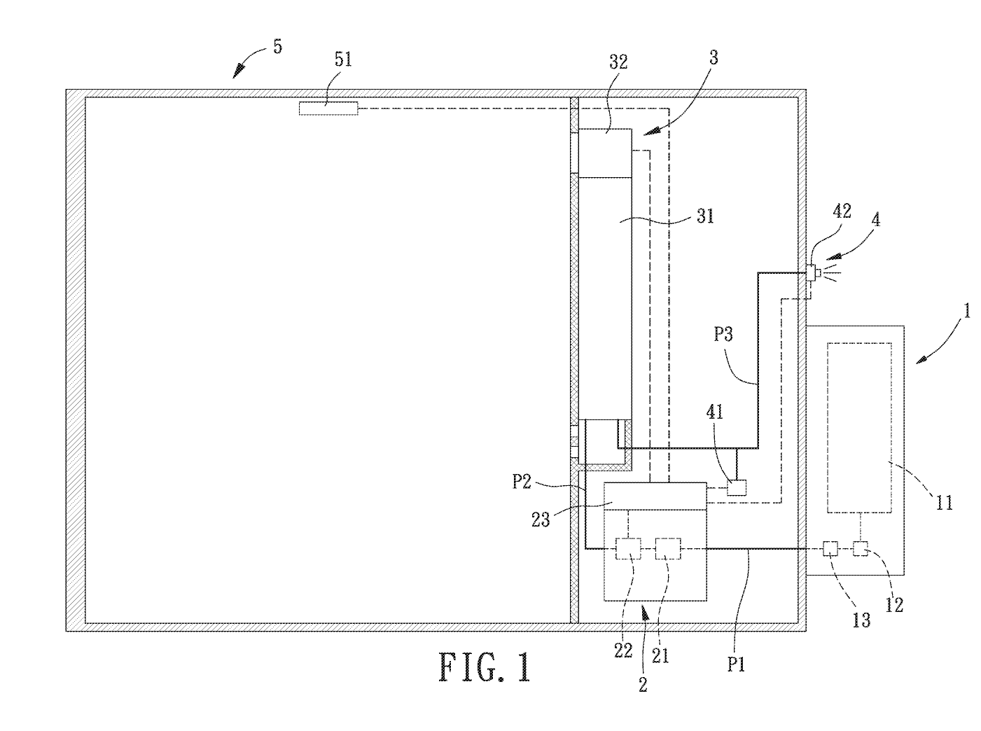

FIG. 1 shows a freezing apparatus of a first embodiment according to the present invention. The freezing apparatus includes a liquefied gas supply module 1, a control module 2, a cooling module 3, and an exhaust module 4. The freezing apparatus is configured to be used for a refrigerating space 5. The liquefied gas supply module 1 intercommunicates with the control module 2 via a first route P1. The control module 2 intercommunicates with the cooling module 3 via a second route P2. The cooling module 3 intercommunicates with the exhaust module 4 via a third route P3. The cooling module 3 is disposed in the refrigerating space 5.

The liquefied gas supply module 1 includes a liquefied gas tank 11 that can be used to store a high pressure liquefied gas having high heat of vaporization and high chemical inertia, such as nitrogen, carbon dioxide, etc. The liquefied gas supply module 1 can further include a pressure reducing valve 12 and a pressure gauge 13, with the pressure reducing valve 12 and the pressure gauge 13 mounted to an outlet of the liquefied gas tank 11. The pressure reducing valve 12 can be used to control the pressure and flow of the liquefied gas entering the first route P1. The pressure gauge 13 can be used to monitor the pressure inside the liquefied gas tank 11, thereby knowing the residual amount of the liquefied gas. Thus, the liquefied gas tank 11 can be replaced when the liquefied gas in the liquefied gas tank 11 is used up.

The control module 2 intercommunicates with the first route P1 via a needle valve 21 to control the flow of the liquefied gas entering the control module 2. The needle valve 21 is connected to an electromagnetic valve 22 electrically connected to a control unit 23. The control unit 23 controls opening and closing of the electromagnetic valve 22, such that the liquefied gas can flow through the needle valve 21 and the electromagnetic valve 22 and then enters the second route P2. Furthermore, the control unit 23 is electrically connected to the cooling module 3, the exhaust module 4, and the refrigerating space 5.

The cooling module 3 includes a vaporization chamber 31 connected to the second rote P2. The liquefied gas can be transformed from a liquid state into a gaseous state in the vaporization chamber 31 and can absorb a large quantity of heat energy to supply the heat of vaporization during the transformation, such that the temperature of the vaporization chamber 31 drops suddenly and such that the vaporization chamber 31 absorbs heat energy from the outside. The vaporization chamber 31 can be coil-shaped and can be made of a thermally conductive material. A plurality of blades can be mounted to an outer surface of the vaporization chamber 31 to increase the contact area between the outer surface of the vaporization chamber 31 and air, increasing the heat absorbing efficiency and accelerating the temperature reducing effect. Furthermore, a fan 32 can be mounted to an outer side of an end of the vaporization chamber 31 and is electrically connected to the control unit 23. The control unit 23 activates the fan 32 to draw air to flow through the outer face of the vaporization chamber 31, and the vaporization chamber 31 absorbs the heat energy in the air. The cooled air thus generated is guided by the fan 32 into the refrigerating space 5. After gasification into the gaseous state, the liquefied gas is exhausted via the third route P3.

The exhaust module 4 includes a pressure detection unit 41 and an exhaust valve 42 intercommunicating with the vaporization chamber 31. The pressure detection unit 41 and the exhaust valve 42 are electrically connected to the control unit 23. The pressure detection unit 41 detects the pressure of the gas in the third route P3. The pressure data is transmitted to the control unit 23, such that the control unit 23 can control opening and closing of the exhaust valve 42. Thus, the gas can be properly discharged to the ambience via the exhaust valve 42, adjusting the pressure in the gas in the third route P3 and the vaporization chamber 31. The pressure detection unit 41 can be a pressure transducer.

The refrigerating space 5 is a thermally insulated space. The heat energy in the refrigerating space 5 is absorbed by the cooling module 3, and the external heat outside of the refrigerating space 5 cannot enter the refrigerating space 5. Thus, the refrigerating space 5 forms a storage space having a relatively low temperature. A temperature detecting unit 51 can be mounted in the refrigerating space 5 and is electrically controlled to the control unit 23. The temperature detecting unit 51 detects the temperature in the refrigerating space 5 and transmits the temperature data to the control unit 23. The temperature detecting unit 51 can be a thermometer.

According to the above structure, in use of the refrigerating apparats according to the present invention, the pressure reducing valve 12 and the needle valve 21 are opened and adjusted to control the pressure and flow of the liquefied gas outputted by the liquefied gas tank 11. Then, the control unit 23 compares the temperature of the refrigerating space 5 detected by the temperature detecting unit 51 and a target temperature. When the target temperature is lower than the temperature of the temperature detecting unit 51, the control unit 23 controls the electromagnetic valve 22 to open intermittently, such that the liquefied gas enters the vaporization chamber 31 in batch to absorb the heat and to reduce the temperature until the temperature of the refrigerating space 5 is reduced to the target temperature. Then, the electromagnetic valve 22 is closed.

The pressure detection unit 41 detects the pressure in the third route P3. When the pressure of the gas in the third route P3 increases, the control unit 23 judges the pressure and determines opening of the exhaust valve 42 to discharge gasified gas, releasing the heat energy together with the gasified gas and avoiding the vaporization chamber 31 from being damaged by high pressure.

In a case that the liquefied gas in the liquefied gas tank 11 is used up, the pressure gauge 13 provides a reminding function of replacing the liquefied gas tank 11 in time, maintaining operation of the freezing apparatus according to the present invention.

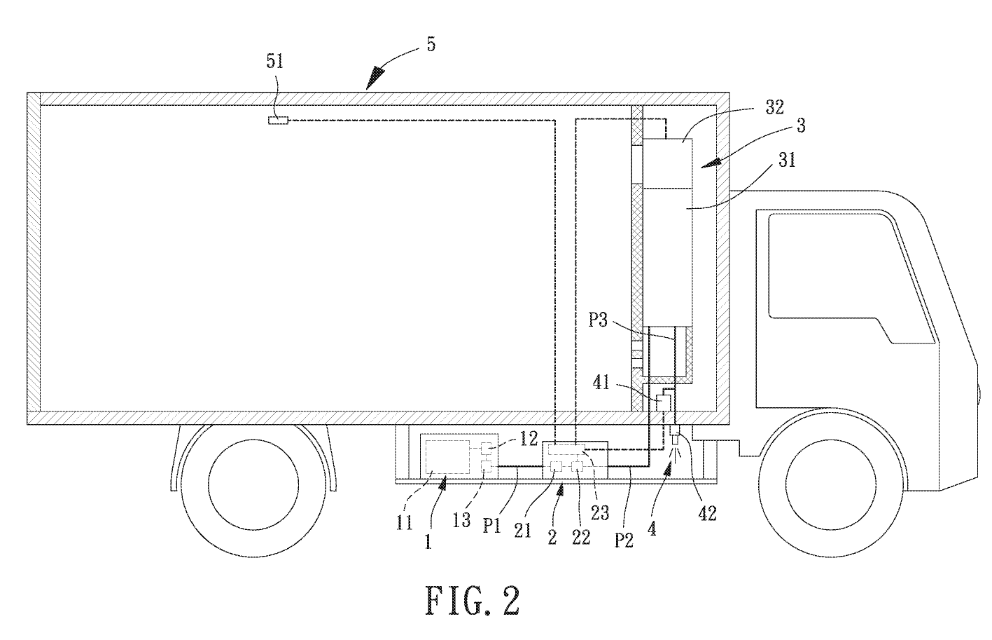

FIG. 2 shows a freezing apparatus of a second embodiment according to the present invention. In this embodiment, the spatial arrangement is modified to fit a vehicle. The liquefied gas supply module 1 and the control module 2 are disposed at a bottom of the vehicle to save space while permitting easy operation and replacement. Furthermore, the exhaust direction of the exhaust valve 42 is towards the ground to avoid accidental injuries while the high pressure gas is ejected during movement of the vehicle. However, the exhaust direction of the exhaust valve 42 can be upward. The present invention is not limited in this regard. The vehicle can be a combination truck, a truck, a van, or any transportation tool capable of towing a cargo container or having a space for goods.

In view of the foregoing, the freezing apparatus according to the present invention uses a liquefied gas that transforms from a liquid state into a gaseous state in the vaporization chamber 31 while absorbing a large quantity of heat energy to supply the heat of vaporization. The sudden temperature drop of the vaporization chamber 31 can be used to refrigerate the refrigerating space 5. Thus, the freezing apparatus according to the present invention does not need any compressors and, thus, saves energy and is not limited by the power source. Furthermore, waste gas and noise are not generated. Furthermore, in the freezing apparatus according to the present invention, the vaporization undergoes in the vaporization chamber 31, but the liquefied gas does not enter the refrigerating space 5 during the vaporization procedure, providing a uniform temperature reducing effect while preventing a worker in the refrigerating space 5 from inhaling a large amount of liquefied gas and from subsequent hypoxia and suffocation. The freezing apparatus according to the present invention can be used to transport articles preserved at a low temperature without the need of compressors, saving the space and reducing the load.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A cooling apparatus configured to be used for a refrigerating space, with the cooling apparatus comprising:
a liquefied gas supply module including a liquefied gas tank;
a control module including an electromagnetic valve intercommunicating with the liquefied gas tank and a control unit electrically connected to the electromagnetic valve;
a cooling module mounted in the refrigerating space and including a vaporization chamber intercommunicating with the electromagnetic valve; and
an exhaust module including an exhaust valve intercommunicating with the vaporization chamber, wherein the exhaust valve is electrically connected to the control unit.

2. The cooling apparatus as claimed in claim 1, wherein the liquefied gas tank stores a liquefied gas, and wherein the liquefied gas is liquefied nitrogen or liquefied carbon dioxide.

3. The cooling apparatus as claimed in claim 1, further comprising a pressure reducing valve and a pressure gauge, wherein the pressure reducing valve and the pressure gauge are mounted to an outlet of the liquefied gas tank.

4. The cooling apparatus as claimed in claim 1, further comprising a needle valve mounted between the electromagnetic valve and the liquefied gas tank.

5. The cooling apparatus as claimed in claim 1, wherein the vaporization chamber is coil-shaped.

6. The free cooling zing apparatus as claimed in claim 1, further comprising a plurality of blades mounted to an outer surface of the vaporization chamber.

7. The cooling apparatus as claimed in claim 1, further comprising a fan mounted to an outer side of an end of the vaporization chamber, wherein the fan is electrically connected to the control unit.

8. The cooling apparatus as claimed in claim 1, further comprising a pressure detection unit electrically connected to the control unit and intercommunicating with the vaporization chamber, wherein the pressure detection unit is a pressure transducer.

9. The cooling apparatus as claimed in claim 1, further comprising a temperature detecting unit electrically controlled to the control unit and mounted in the refrigerating space, wherein the temperature detecting unit is a thermometer.

10. A vehicle including a cooling apparatus as claimed in claim 1.

11. The vehicle as claimed in claim 10, wherein the liquefied gas tank stores a liquefied gas, and wherein the liquefied gas is liquefied nitrogen or liquefied carbon dioxide.

12. The vehicle as claimed in claim 10, further comprising a pressure reducing valve and a pressure gauge, wherein the pressure reducing valve and the pressure gauge are mounted to an outlet of the liquefied gas tank.

13. The vehicle as claimed in claim 10, further comprising a needle valve mounted between the electromagnetic valve and the liquefied gas tank.

14. The vehicle as claimed in claim 10, wherein the vaporization chamber is coil-shaped.

15. The vehicle as claimed in claim 10, further comprising a plurality of blades mounted to an outer surface of the vaporization chamber.

16. The vehicle as claimed in claim 10, further comprising a fan mounted to an outer side of an end of the vaporization chamber, wherein the fan is electrically connected to the control unit.

17. The vehicle as claimed in claim 10, further comprising a pressure detection unit electrically connected to the control unit and intercommunicating with the vaporization chamber, wherein the pressure detection unit is a pressure transducer.

18. The vehicle as claimed in claim 10, further comprising a temperature detecting unit electrically controlled to the control unit and mounted in the refrigerating space, wherein the temperature detecting unit is a thermometer.
